(19) United States
(12) Patent Application Publication
(10) Pub. No.: US 2007/0051333 A1
(43) Pub. Date: Mar. 8, 2007

(54) In-cylinder injection type spark ignition internal combustion engine

(75) Inventor: Takeshi Ashizawa, Yokohama-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: TOYOTA JIDOSHA KABUSHIKI KAISHA, Toyota-shi (JP)

(21) Appl. No.: 11/498,736

(22) Filed: Aug. 4, 2006

(30) Foreign Application Priority Data
Sep. 2, 2005 (JP) 2005-254873

(51) Int. Cl. F02B 23/10

(52) U.S. Cl. 123/169 EL

(57) ABSTRACT

In an in-cylinder injection type spark ignition internal combustion engine which uses a spark plug to ignite and burn an air-fuel mixture flow formed by fuel which is injected from a fuel injection valve and flies around inside a cylinder while mixing with air, the spark plug has a first electrode formed on its center axis and a second electrode having a substantially L-shaped cross section, a spark gap is formed between the first electrode and the second electrode, and the spark plug is arranged such that the air-fuel mixture flow passes directly through the spark gap.

### INCORPORATION BY REFERENCE

The disclosure of Japanese Patent Application No. 2005-254873 filed on Sep. 2, 2005, including the specification, drawings and abstract is incorporated herein by reference in its entirety.

### BACKGROUND OF THE INVENTION

1. Field of the Invention

The invention relates to an in-cylinder injection type spark ignition internal combustion engine.

2. Description of the Related Art

Stratified-charge combustion is known which enables combustion in which the air-fuel ratio within the entire cylinder is leaner than the stoichiometric air-fuel ratio by forming a flammable air-fuel mixture in only part of the cylinder using fuel injected on the compression stroke and igniting and burning that flammable air-fuel mixture using a spark plug. In stratified-charge combustion, however, the spark gap of the spark plug must be positioned within the flammable air-fuel mixture at the ignition timing. To achieve this, one proposal calls for angling the injected fuel for creating the flammable air-fuel mixture toward the spark plug using a cavity formed in the top of the piston. If this is done, however, the fuel injection timing becomes limited by the position of the piston.

In order to make it possible to set the fuel injection timing without this kind of limitation, Japanese Utility Model Publication HEI 4-107485, for example, discloses an in-cylinder type spark ignition internal combustion engine which injects fuel from a fuel injection valve arranged in substantially the center in the top portion of a cylinder, creates an air-fuel mixture flow from fuel that flies around inside the cylinder while mixing with air, and ignites and burns that air-fuel mixture using a spark plug.

In this in-cylinder injection type spark ignition internal combustion engine, a ground electrode of a spark plug is positioned on the fuel injection valve side of a center electrode. As a result, the air-fuel mixture flow hits the ground electrode but does not directly hit the center electrode that is positioned behind the ground electrode. In this way, the center electrode does not get wet from the liquid fuel contained in the air-fuel mixture flow, thus making it possible to inhibit a misfire.

In the foregoing in-cylinder injection type spark ignition internal combustion engine, the center electrode is able to be prevented from getting wet by the liquid fuel. On the other hand, however, it is not guaranteed that the air-fuel mixture flow will contact the spark gap between the ground electrode and the center electrode so it is possible that ignition of the air-fuel mixture flow might have trouble igniting.

### SUMMARY OF THE INVENTION

This invention thus provides an in-cylinder injection type spark ignition internal combustion engine which is able to realize superb stratified-charge combustion by more reliably igniting and burning an air-fuel mixture flow formed by fuel which is injected from a fuel injection valve into a cylinder and flies around inside the cylinder while mixing with air, using a spark plug.

An in-cylinder injection type spark ignition internal combustion engine according to one aspect of the invention is provided with a fuel injection valve which injects fuel directly into a cylinder, and a spark plug. This internal combustion engine uses the spark plug to ignite and burn an air-fuel mixture flow formed by fuel which is injected from the fuel injection valve and flies around inside the cylinder while mixing with air. The spark plug has a first electrode and a second electrode. The second electrode has a substantially Lshaped cross section. A spark gap formed between the first electrode and the second electrode has openings in three directions, and the spark plug is arranged such that the air-fuel mixture flow passes through the spark gap by traveling through openings in two directions which oppose one another, from among the openings.

According to the foregoing in-cylinder injection type spark ignition internal combustion engine, the spark gap of the spark plug, which is formed between the first electrode and the second electrode has openings in three directions, and the spark plug is arranged such that the air-fuel mixture flow, which is formed by fuel that is injected from the fuel injection valve and flies around in the cylinder while mixing with intake air, passes through the spark gap by traveling through openings in two directions which oppose one another, from among the openings. As a result, good stratified-charge combustion is able to be realized because the air-fuel mixture flow that passes through the spark gap is reliably ignited and burned by the spark plug instead of perpendicularly hitting the second electrode of the spark plug and being blocked from passing through the spark gap.

Because the fuel has mixed with the intake air, the ratio of liquid fuel in the air-fuel mixture flow that passes through the spark gap is low so the first electrode does not get wet enough to cause a misfire. Also, the arc produced across the spark gap extends downstream together with the air-fuel mixture flow so air-fuel mixture flow that has already passed through the spark gap can also be simultaneously ignited. Igniting the air-fuel ignition flow over a wide range in this manner further improves the ignitability of the air-fuel mixture flow. If the spark plug were arranged such that the air-fuel mixture flow were to enter the spark gap through the other opening, other than the two opposing openings, the arc produced in the spark gap would be blocked by the second electrode and thus be unable to extend downstream. As a result, ignitability of the air-fuel mixture flow would not be able to be improved in the manner described above.

The fuel injection valve may be arranged in substantially the center in a top portion of the cylinder and inject fuel in a plurality of directions at a downward angle in a substantially radial shape, and the spark plug may be arranged such that the air-fuel mixture flow, which is formed by fuel that is injected in one of the plurality of directions and flies around inside the cylinder while mixing with air, passes through the spark gap by traveling through the openings in two directions which oppose one another, from among the openings.

Accordingly, the air-fuel mixture flows formed by the fuel injected in the plurality of directions during the first half of the injecting timing connect in a ring shape near the top of the piston as an air-fuel mixture that contains almost no liquid fuel because the fuel progressively mixes with the intake air at the ignition timing. The air-fuel mixture flow formed by the fuel injected in one direction in the latter half of the injection timing passes through the spark gap and extends the arc downstream at the ignition timing. As a result, the air-fuel mixture flow is reliably ignited and burned over a large range. The air-fuel mixture that is connected in a ring shape is also reliably burned by the flame so good stratified-charge combustion can be realized.

Also, the spark plug may be arranged such that an outer peripheral portion of the air-fuel mixture flow passes directly through the spark gap.

An in-cylinder injection type spark ignition internal combustion engine according to another aspect of the invention is provided with a fuel injection valve which injects fuel directly into a cylinder, and a spark plug. This internal combustion engine uses the spark plug to ignite and burn an air-fuel mixture flow formed by fuel which is injected from the fuel injection valve and flies around inside the cylinder while mixing with air. The spark plug has a first electrode and a second electrode. The second electrode has a substantially L-shaped cross section. A spark gap is formed between the first electrode and the second electrode, and the spark plug is arranged such that the air-fuel mixture flow passes directly through this spark gap.

### BRIEF DESCRIPTION OF THE DRAWINGS

The foregoing and further objects, features and advantages of the invention will become apparent from the following description of preferred embodiments with reference to the accompanying drawings, wherein like numerals are used to represent like elements and wherein:

FIG. 1 is a longitudinal sectional view showing a frame format of an in-cylinder injection type spark injection internal combustion engine according to an example embodiment of the invention;

FIG. 2 is a bottom view of a cylinder head as viewed from a piston side of the in-cylinder injection type spark injection internal combustion engine in FIG. 1;

FIG. 3 is an enlarged view of the area near a spark plug in FIG. 1;

FIG. 4 is a side view of the spark plug in FIG. 3;

FIG. 5 is an enlarged view of the area near the spark plug in FIG. 2; and

FIG. 6 is an enlarged view of the area near a spark plug according to related art.

### DETAILED DESCRIPTION OF THE PREFERRED EMBODIMENTS

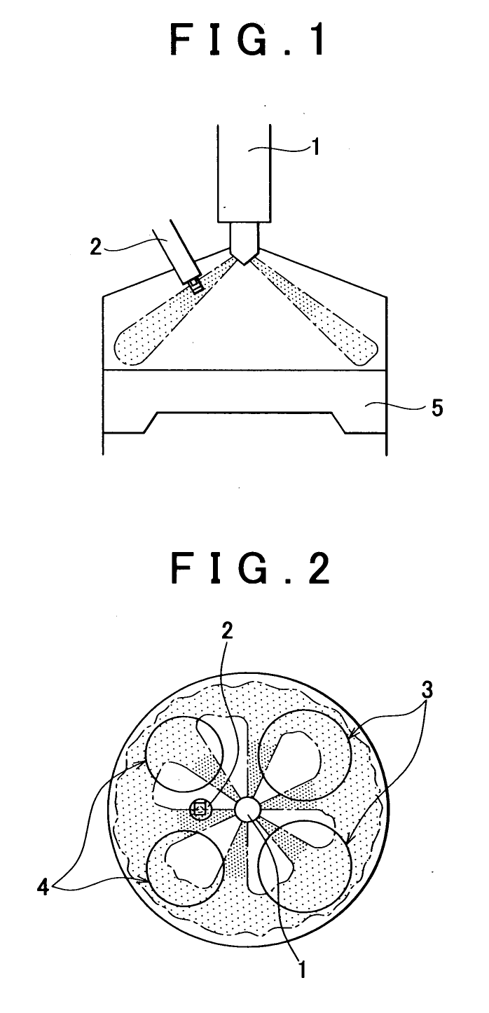

FIG. 1 is a longitudinal sectional view showing a frame format of an in-cylinder injection type spark injection internal combustion engine according to an example embodiment of the invention. FIG. 2 is a bottom view of a cylinder head as viewed from a piston side of the internal combustion engine in FIG. 1. The structure of the in-cylinder injection type spark injection internal combustion engine according to this example embodiment will now be described with reference to FIGS. 1 and 2. The internal combustion engine is provided with a fuel injection valve 1, a spark plug 2, a pair of intake valves 3, a pair of exhaust valves 4, and a piston 5. The fuel injection valve 1 is arranged in substantially the center of the top portion of a cylinder and is used to inject fuel directly into the cylinder. The spark plug 2 is arranged near the fuel injection valve 1. In this example embodiment, the exhaust valves 4 are smaller than the intake valves 3 and the spark plug 2 is arranged between the two exhaust valves 4.

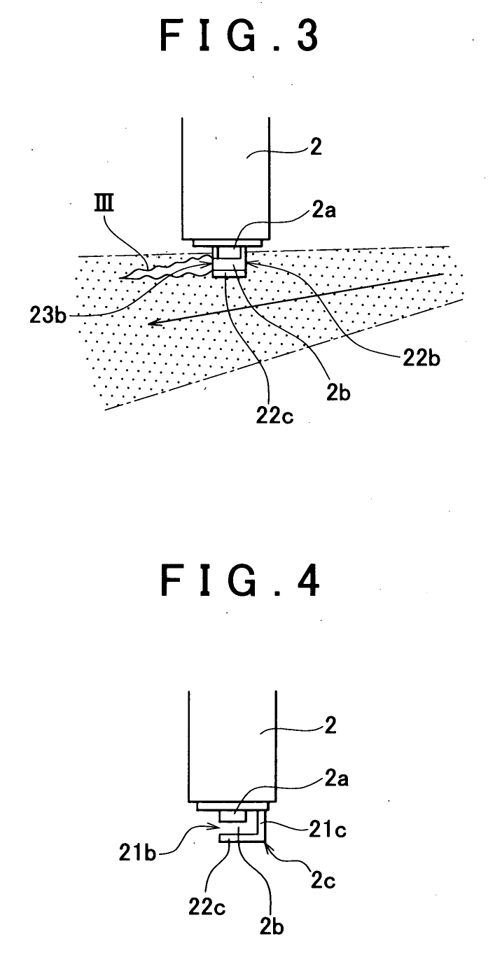

The fuel injection valve 1 injects fuel in a plurality of directions at a downward angle generally radially when viewed from above the piston 5. In this example embodiment, the fuel injection valve 1 injects fuel in six directions. FIG. 3 is an enlarged view of the area near the spark plug shown in FIG. 1, and FIG. 4 is a side view of the spark plug shown in FIG. 3. As shown in FIGS. 3 and 4, a center electrode 2a on the center axis and another electrode 2c which forms a spark gap 2b between it and the center electrode 2a are provided on the tip end of the spark plug 2. Typically, the other electrode is a ground electrode, but the center electrode may also be the ground electrode. The other electrode has a generally L-shaped cross-section, as shown in FIG. 4, by having a parallel portion 21c which is substantially parallel with the center axis of the spark plug 2 and a perpendicular portion 22c which is substantially perpendicular with respect to the center axis of the spark plug 2.

In this way, the spark gap 2b of the spark plug 2 is closed in two directions by the parallel portion 21c and the perpendicular portion 22c of the other electrode 2c while being open in three directions. Of these three openings, one is a front opening 21b which is perpendicular to the parallel portion 21c of the other electrode 2c. The remaining two openings are side openings 22b and 23b which are parallel to the parallel portion 21c of the other electrode 2c and which oppose one another.

The fuel injection valve 1 has a plurality of holes with circular cross-sections and thus injects column-shaped streams of fuel in a plurality of directions. The fuel injected in column-shaped streams from the fuel injection valve 1 is vaporized by the friction with air as it mixes with air flying around in the cylinder, thus forming an air-fuel mixture flow that expands in a conical shape as shown in FIGS. 1 and 2. During stratified-charge combustion, fuel is injected in the latter half of the compression stroke. The fuel that is injected in the first half of the fuel injection timing sufficiently mixes with the air and is vaporized to form an air-fuel mixture at the ignition timing. This air-fuel mixture connects with the air-fuel mixtures of other injected fuel that are formed similarly adjacent to that air-fuel mixture such that a ring-shaped air-fuel mixture is created near the top surface of the piston, as shown in FIGS. 1 and 2.

Meanwhile, in each injection direction, the fuel injected in the latter half of the injection timing connects with the ring-shaped air-fuel mixture as an air-fuel mixture flow that expands in a conical shape at the ignition timing immediately after the fuel has finished being injected. Thus, if one of the air-fuel mixture flows that expands in a conical shape is ignited by the spark plug 2 so that it burns, the flame will propagate to the ring-shaped air-fuel mixture. Also, the other air-fuel mixture flow that expands in a conical shape progressively burns in a direction to the inside of the burning ring-shaped air-fuel mixture so all of the injected fuel is able to be reliably burned. As a result, stratified-charge combustion which is leaner than the stoichiometric air-fuel ratio is able to be successfully realized in the entire cylinder.

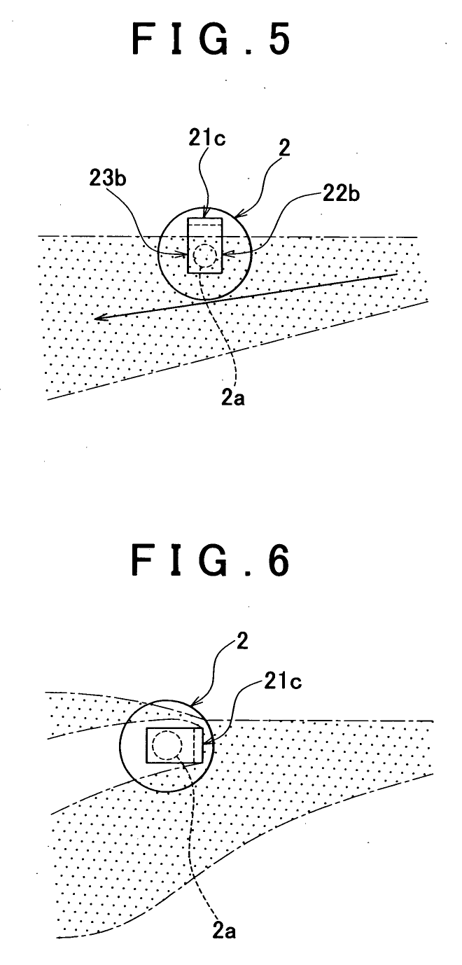

In this example embodiment, the arrangement of the spark plug for reliably igniting and burning one of the air-fuel mixture flows that expands in a conical shape while mixing with the air is shown in FIG. 3 as well as FIG. 5 which is an enlarged view of the area near the spark plug shown in FIG. 2. The spark plug 2 is arranged so that the air-fuel mixture flow, which is formed by fuel that mixes with air while flying around in the cylinder, passes through the spark gap 2b by traveling through the two opposing side openings 22b and 23b, of the three openings, of the spark gap 2b of the spark plug 2. That is, the spark plug 2 is arranged so that both the parallel portion 21c and the perpendicular portion 22c of the other electrode 2c of the spark plug 2 are substantially parallel with part of the air-fuel mixture flow that passes through the spark gap 2b. In this example embodiment, because the air-fuel mixture flow is conical, the parallel portion 21c and the perpendicular portion 22c of the other electrode 2c of the spark plug 2 are not parallel but rather slightly angled with respect to the direction in which fuel is injected as shown by the arrow.

If the spark plug 2 were arranged so that the parallel portion 21c of the other electrode 2c of the spark plug 2 were facing the air-fuel mixture flow, as shown in FIG. 6, the air-fuel mixture flow would hit the parallel portion 21c of the other electrode 2c of the spark plug 2 perpendicularly and split. As a result, the air-fuel mixture flow may not pass through the spark gap 2b positioned behind the parallel portion 21c, as shown in FIG. 6. In this case, the air-fuel mixture flow may have difficulty igniting even if an arc is produced in the ignition gap.

On the other hand, in this example embodiment, because the air-fuel mixture reliably passes through the spark gap 2b of the spark plug, as shown in FIGS. 3 and 5, the air-fuel mixture flow is able to be reliably ignited and burned by the arc produced in the spark gap. Because the air-fuel mixture that passes through the spark gap 2b is formed by fuel that has mixed with air while flying around in the cylinder, it does not contain enough liquid fuel to wet the center electrode 2a enough to cause a misfire.

Also, as shown in FIG. 3, an arc III produced in the spark gap 2b extends toward the downstream side together with the air-fuel mixture flow. As a result, air-fuel mixture flow that has already passed through the spark gap 2b is also able to be simultaneously ignited. Igniting the air-fuel ignition flow over a wide range in this manner further improves the ignitability of the air-fuel mixture flow. If the spark plug 2 were arranged such that the air-fuel mixture flow were to enter the spark gap 2b through the front opening 21b (i.e., arranged facing the direction opposite that (i.e., symmetrical to the position) shown in FIG. 6), the arc produced in the spark gap 2b would be blocked by the other electrode 2c, making it difficult for the arc to extend to the downstream side. As a result, ignitability of the air-fuel mixture flow would not be able to be improved as it is with the example embodiment described above.

In this way, the example embodiment is such that fuel injected in a plurality of directions in the first half of the injection timing connects as an air-fuel mixture in a ring-shape near the top surface of the piston at the ignition timing in the last stage of the compression stroke. In this example embodiment, one of the air-fuel mixture flows formed by fuel injected in a plurality of directions in the latter half of the injection timing passes through the spark gap 2b. This air-fuel mixture flow causes the arc III to extend to the downstream side. By reliably igniting and burning this air-fuel mixture flow, the air-fuel mixture that is connected in a ring-shape is also reliably burned by that flame, thus enabling excellent stratified-charge combustion to be achieved.

In this example embodiment, the spark plug 2 is arranged so that the outer peripheral portion of the air-fuel mixture flow that expands in a conical shape passes through the spark gap 2b of the spark plug 2. The outer peripheral portion of the conical air-fuel mixture flow is formed by fuel that has dispersed to the outside while vaporizing from the center portion. The foregoing arrangement of the spark plug 2 reduces the likelihood of the center electrode 2a getting wet from liquid fuel when the air-fuel mixture flow passes through the spark gap 2b. Of course, increasing the distance from the fuel injection valve 1 to the spark plug 2 a certain degree results in a lower ratio of liquid fuel in the air-fuel mixture flow because the center part of the conical air-fuel mixture flow has had a chance to sufficiently mix with air. In this case, the center part of the conical air-fuel mixture flow may also pass through the spark gap 2b of the spark plug 2. In this case, the parallel portion 21c and the perpendicular portion 22c of the other electrode 2c of the spark plug 2 are substantially parallel to the direction in which fuel is injected.

In this example embodiment, the fuel injection valve 1 injects fuel in six directions, but the invention is of course not limited to this. That is, the number of directions in which the fuel is injected from the fuel injection valve 1 is arbitrary and can be set appropriately. For example, the invention may also be applied to a case in which fuel is only injected in one direction from the fuel injection valve 1. Also, in the example embodiment, the fuel injection valve 1 injects the fuel in column-shaped streams, but it may also inject the fuel in flat fan-shaped streams or in conical-shaped streams. In either case, the spark plug 2 need only be arranged such that the air-fuel mixture flow, which is formed by fuel that is injected from the fuel injection valve and flies around inside the cylinder while mixing with air, passes through the spark gap 2b of the spark plug 2 by traveling through the opposing side openings 22b and 23b. At this time, the air-fuel mixture flow that passes through the spark gap 2b by traveling through the side openings 22b and 23b does not necessarily need to pass through the spark gap 2b parallel to the parallel portion 21c and the perpendicular portion 22c of the other electrode 2c of the spark plug 2. Because the air-fuel mixture flow formed by fuel injected in the latter half of the injection timing is reliably ignited by the arc that extends to the downstream side due to the air-fuel mixture flow passing through the spark gap 2b, all of the injected fuel, including the air-fuel mixture formed by fuel injected in the first half of the injection timing, is able to be burned well.

While the invention has been described with reference to exemplary embodiments thereof, it is to be understood that the invention is not limited to the exemplary embodiments or constructions. To the contrary, the invention is intended to cover various modifications and equivalent arrangements. In addition, while the various elements of the exemplary embodiments are shown in various combinations and configurations, which are exemplary, other combinations and configurations, including more, less or only a single element, are also within the spirit and scope of the invention.

What is claimed is:

1. An in-cylinder injection type spark ignition internal combustion engine comprising:
a fuel injection valve which injects fuel directly into a cylinder;
a spark plug which ignites and burns an air-fuel mixture flow formed by fuel which is injected from the fuel injection valve and flies around inside the cylinder while mixing with air;
a first electrode of the spark plug; and
a second electrode of the spark plug, which has a substantially L-shaped cross section; wherein
the first electrode and the second electrode define a spark gap and the spark gap has openings in two directions through which the air-fuel mixture flow passes.

2. The in-cylinder injection type spark ignition internal combustion engine according to claim 1, wherein the fuel injection valve is arranged in substantially the center in a top portion of the cylinder and injects fuel in a plurality of directions at a downward angle in a substantially radial shape, and the spark plug is arranged such that the air-fuel mixture flow, which is formed by fuel that is injected in one of the plurality of directions and flies around inside the cylinder while mixing with air, passes through the spark gap by traveling through the openings in two directions.

3. The in-cylinder injection type spark ignition internal combustion engine according to claim 1, wherein the spark plug is arranged such that an outer peripheral portion of the air-fuel mixture flow passes directly through the spark gap.

4. An in-cylinder injection type spark ignition internal combustion engine comprising:
a fuel injection valve which injects fuel directly into a cylinder;
a spark plug which ignites and burns an air-fuel mixture flow formed by fuel which is injected from the fuel injection valve and flies around inside the cylinder while mixing with air;
a first electrode of the spark plug; and
a second electrode of the spark plug, which has a substantially L-shaped cross section; wherein
the first electrode and the second electrode define a spark gap and the spark gap through which the air-fuel mixture flow directly passes.

5. The in-cylinder injection type spark ignition internal combustion engine according to claim 4, wherein the fuel injection valve is arranged in substantially the center in a top portion of the cylinder and injects fuel in a plurality of directions at a downward angle in a substantially radial shape, and the spark plug is arranged such that the air-fuel mixture flow, which is formed by fuel that is injected in one of the plurality of directions and flies around inside the cylinder while mixing with air, passes directly through the spark gap.

6. The in-cylinder injection type spark ignition internal combustion engine according to claim 4, wherein the spark plug is arranged such that an outer peripheral portion of the air-fuel mixture flow passes directly through the spark gap.
